(19) United States
(12) Patent Application Publication
(10) Pub. No.: US 2021/0285770 A1
(43) Pub. Date: Sep. 16, 2021

(54) METHOD AND APPARATUS FOR PLANNING NAVIGATION ROUTE, SERVER AND STORAGE MEDIUM

(71) Applicant: Baidu Online Network Technology (Beijing) Co., Ltd., Beijing (CN)

(72) Inventor: Jinzhu LIN, Beijing (CN)

(21) Appl. No.: 17/017,514

(22) Filed: Sep. 10, 2020

(30) Foreign Application Priority Data
Mar. 13, 2020 (CN) 202010177564.8

(51) Int. Cl. G01C 21/00; G01C 21/34; G01C 21/30

(52) U.S. Cl. CPC G01C 21/005; G01C 21/3407; H04L 67/12; G01C 21/3484; G01C 21/30

(57) ABSTRACT

A method for planning a navigation route, apparatus, server and storage medium. When executed by the cross-region-navigation server, a specific implementation solution is: acquiring a request for global navigation of a user, where the request for the global navigation includes a user start point and a user end point, and travel from the user start point to the user end point is required to pass through at least two administrative regions; generating at least two requests for local navigation for the at least two administrative regions; controlling at least two local-navigation servers to respectively process associated requests for the local navigation, wherein each of the local navigation servers is associated with at least one of the administrative regions; and determining a target global navigation route for the user based on candidate local navigation routes fed back by the at least two local-navigation servers.

### CROSS-REFERENCE TO RELATED DISCLOSURES

This application claims priority to Chinese Patent Application No. 202010177564.8, filed with the China National Intellectual Property Administration (CNIPA) on Mar. 13, 2020, the contents of which are incorporated herein by reference in their entirety.

### TECHNICAL FIELD

Embodiments of the present disclosure relate to the field of computer technologies, and more particularly to the field of navigation technologies, and more particularly to a method and apparatus for planning a navigation route, server, and storage medium.

### BACKGROUND

Global route planning refers to route planning with any two points on the entire globe as the starting point and the end point. Due to the large amount of global road network data, the conventional navigation technology has to process a large amount of data in the process of compiling navigation data. For example, if the global data were compiled together, it would take about 800G of memory for data processing. However, the performance of the existing navigation server cannot meet this requirement. Therefore, the current navigation service can only provide navigation route planning in the small areas, and cannot implement real global route planning.

### SUMMARY

Embodiments of the present disclosure provide a method and apparatus for planning a navigation route, a server and a storage medium. While the global navigation route planning across regions is implemented, the data amount processed by the cross-region-navigation server and the local-navigation server of each region is greatly reduced.

In a first aspect, some embodiments of the present disclosure provide a method for planning a navigation route, performed by a cross-region-navigation server, the method includes:

acquiring a request for global navigation of a user, wherein the request for the global navigation includes a user start point and a user end point, and travel from the user start point to the user endpoint is required to pass through at least two administrative regions;

generating at least two requests for local navigation for the at least two administrative regions;

controlling at least two local-navigation servers to respectively process associated requests for the local navigation, wherein each of the local navigation servers is associated with at least one of the administrative regions; and

determining a target global navigation route for the user based on candidate local navigation routes fed back by the at least two local-navigation servers.

An embodiment of the above disclosure has following advantages or beneficial effects: after acquiring a request for global navigation of a user, the cross-region-navigation server partitions the request for global navigation into a plurality of requests for local navigation corresponding to a plurality of administrative regions through which a travel from the start point to the end point included in the request for global navigation passes, controls a local-navigation server corresponding to an administrative region to process the request for local navigation corresponding to the administrative region, and determines a target global navigation route of the user based on the candidate local navigation routes fed back by the local navigation servers. According to an embodiment of the present disclosure, after the cross-region-navigation server splits the request for global navigation of the user, the cross-region-navigation server requests the cooperation from a plurality of local-navigation servers to determine a target global navigation route. While the global navigation route planning across regions is implemented, the data amount processed by the cross-region-navigation server and the local-navigation server of each region is greatly reduced. It provides a new idea for global navigation route planning.

Furthermore, the method for planning a navigation route described in the above embodiment of present disclosure includes:

Alternatively, the generating at least two requests for the local navigation for the at least two administrative regions includes:

determining an adjacent point between adjacent administrative regions; and

for each of the adjacent administrative regions, generating a request for the local navigation for the administrative region based on at least one of the user start point, the adjacent point between the adjacent administrative regions, or the user end point.

An embodiment of the above disclosure has following advantages or beneficial effects: an adjacent point between any adjacent administrative regions in the at least two administrative regions is determined, and a request for local navigation for each administrative region is generated based on the user start point and the user end point included in the request for global navigation and determined adjacent point between the adjacent administrative regions. The accuracy and comprehensiveness of the generated request for local navigation is improved.

Alternatively, the determining the adjacent point between the adjacent administrative regions includes:

determining the adjacent point between the adjacent administrative regions based on historical navigation trajectory data and map data of the adjacent administrative regions.

An embodiment of the above disclosure has following advantages or beneficial effects: the adjacent point between the adjacent administrative regions is determined based on historical navigation trajectory data and map data of the adjacent administrative regions, which improves accuracy and comprehensiveness in determining the adjacent point.

Alternatively, the generating the request for the local navigation for the administrative region based on at least one of the user start point, the adjacent point between the adjacent administrative regions, or the user end point includes:

determining a local start point and a local end point of the administrative region based on at least one of the user start point, the adjacent point between the adjacent administrative regions, or the user end point; and

generating the request for the local navigation for the administrative region based on the local start point and the local end point of the administrative region.

An embodiment of the above disclosure has following advantages or beneficial effects: for each of the administrative regions, a local start point and a local end point of the administrative region are determined based on at least one of the user start point, the adjacent point between the adjacent administrative regions, or the user end point, and then the request for local navigation from the local start point to the local end point is generated. For each of the administrative regions, the embodiment of the present disclosure can determine all situations of the local start point and the local endpoint included therein, and thus improves the accuracy and comprehensiveness of each of the request for local navigation.

Alternatively, the determining the target global navigation route for the user based on the candidate local navigation routes fed back by the at least two local-navigation servers includes:

determining features of candidate global navigation routes, according to a mapping relationship between the request for the global navigation and the requests for the local navigation, and based on the candidate local navigation routes fed back by the at least two local navigation servers; and

determining the target global navigation route for the user according to the features of the candidate global navigation routes.

An embodiment of the present disclosure has following advantages and technical effects: the respective requests for local navigation are analyzed based on the mapping relationship between the request for global navigation and the requests for local navigation, which may prevent request chaos between the request for global navigation and the requests for local navigation. By analyzing the features of the candidate global navigation routes determined based on the candidate local navigation routes, planning the optimal target navigation route for the user may be realized. The navigation experience of the user is improved.

Alternatively, after the determining the target global navigation route of the user, the method further includes:

generating, during user navigation, requests for local route states of the at least two administrative regions based on the target local navigation routes of the at least two administrative regions included in the target global navigation route;

controlling the at least two local-navigation servers to process associated requests for the local route states; and

determining global route state information of the target global navigation route based on local route state information fed back by the at least two local-navigation servers.

An embodiment of the present disclosure has following advantages or beneficial effect: after the target global navigation route is determined, requests for local route states of the at least two administrative regions may be generated during the user navigation and sent to the local-navigation servers, and then the global route state information of the target global navigation route may be determined, based on local route state information fed back by the at least two local-navigation servers, and provided to the user, so that the user can know the route state in the navigation process in real time, thereby enriching the navigation service function and improving the navigation experience of the user.

In a second aspect, some embodiments of the present disclose provide an apparatus for planning a navigation route, configured in a cross-region-navigation server, the apparatus includes:

a first request acquisition module, configured to acquire a request for global navigation of a user, wherein the request for the global navigation includes a user start point and a user end point, and travel from the user start point to the user end point is required to pass through at least two administrative regions;

a second request generation module, configured to generate at least two requests for local navigation for the at least two administrative regions;

a second request processing module, configured to control at least two local-navigation servers to respectively process associated requests for the local navigation, wherein each of the local navigation servers is associated with at least one of the administrative regions; and

a navigation route determination module, configured to determine a target global navigation route for the user based on candidate local navigation routes fed back by the at least two local-navigation servers.

In a third aspect, some embodiments of the present disclosure provide a server, including:

at least one processor; and

a memory in communication with the at least one processor, where the memory stores instructions executable by the at least one processor, when the instructions are executed by the at least one processor, causing the at least one processor to perform the method for planning a navigation route according to any one of the embodiments of the present disclosure.

In a fourth aspect, some embodiments of the present disclosure provide a non-transitory computer-readable storage medium storing computer instructions for causing the computer to perform the method for planning a navigation route according to any one of the embodiments of the present disclosure.

An embodiment of the present disclosure has following advantages or beneficial effects: after acquiring a request for global navigation of a user, the cross-region-navigation server partitions the request for global navigation into a plurality of requests for local navigation corresponding to a plurality of administrative regions through which a travel from the start point to the end point included in the request for global navigation passes, controls a local-navigation server corresponding to an administrative region to process the request for local navigation corresponding to the administrative region, and determines a target global navigation route of the user based on the candidate local navigation routes fed back by the local navigation servers. According to an embodiment of the present disclosure, after the cross-region-navigation server splits the request for global navigation of the user, the cross-region-navigation server requests the cooperation from a plurality of local-navigation servers to determine a target global navigation route. While the global navigation route planning across regions is implemented, the data amount processed by the cross-region-navigation server and the local-navigation server of each region is greatly reduced. It provides a new idea for global navigation route planning.

Other effects of the above-mentioned alternative implementations will be described below in conjunction with specific embodiments.

### BRIEF DESCRIPTION OF THE DRAWINGS

The drawings are intended to provide a better understanding of the present disclosure and are not to be construed as limiting the disclosure.

FIG. 1 is a system architecture diagram for performing a method for planning a navigation route according to an embodiment of the present disclosure;

FIG. 2 is a flowchart of a method for planning a navigation route according to a first embodiment of the present disclosure;

FIG. 3A-3B is a schematic diagram of the principle for determining a target global navigation route according to the first embodiment of the present disclosure;

FIG. 4 is a flowchart of a method for planning a navigation route according to a second embodiment of the present disclosure;

FIG. 5 is a schematic diagram of planning a route which passes through three administrative regions according to the second embodiment of the present disclosure;

FIG. 6 is a flowchart of a method for planning a navigation route according to a third embodiment of the present disclosure;

FIG. 7 is a schematic structural diagram of an apparatus for planning a navigation route according to a fourth embodiment of the present disclosure;

FIG. 8 is a block diagram of a server for implementing the method for planning a navigation route according to the fifth embodiment of the present disclosure.

### DETAILED DESCRIPTION OF EMBODIMENTS

Exemplary embodiments of the present disclosure are described below in connection with the accompanying drawings, in which various details of the embodiments of the present disclosure are included to facilitate understanding, and should be considered as exemplary only. Accordingly, one of ordinary skill in the art will recognize that various changes and modifications may be made to the embodiments described herein without departing from the scope and spirit of the present disclosure. Also, for clarity and conciseness, descriptions of well-known functions and structures are omitted in the following description.

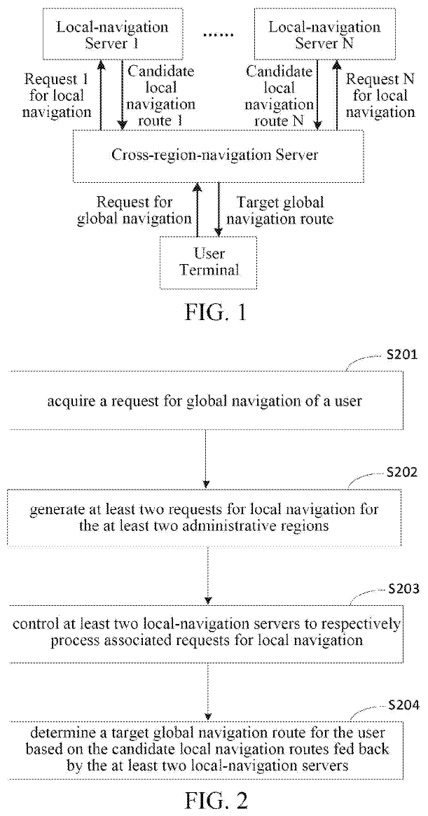

Before introducing the embodiments of the present disclosure, a system architecture for implementing the method for planning a navigation route is described. As shown in FIG. 1, the system architecture for performing the method for planning a navigation route in embodiments of the present disclosure includes a client, a cross-region-navigation server, and at least two local-navigation servers.

The user terminal may be a device terminal, or an application client installed on the device terminal and capable of providing a navigation service, that initiates a request for global navigation in response to an operation of a user. For example, the user terminal may be an application client of a map or the like type. The cross-region-navigation server may be a communication bridge between the user terminal and each of the local-navigation servers, and is used to convert the request for global navigation sent from the user terminal into requests for local navigation and send the requests for local navigation to the local-navigation servers, and is used to generate a final target global navigation route based on the candidate local navigation routes fed back by the local-navigation servers and feck back the generated target global navigation route to the user terminal. A local-navigation server may be configured to, in response to a request for local navigation sent from the cross-region-navigation server, determine a candidate local navigation route corresponding to the request for local navigation, and feedback the determined candidate local navigation route to the cross-region-navigation server. In an embodiment of the present disclosure, there may be a plurality of local-navigation servers. The global map data may be partitioned according to administrative regions, and a local navigation server may be configured for each of the administrative regions after the partition.

Next, based on the system framework described above, the method for planning a navigation route provided in an embodiment of the present disclosure is explained in detail with the cross-region-navigation server as the execution body.

### First Embodiment

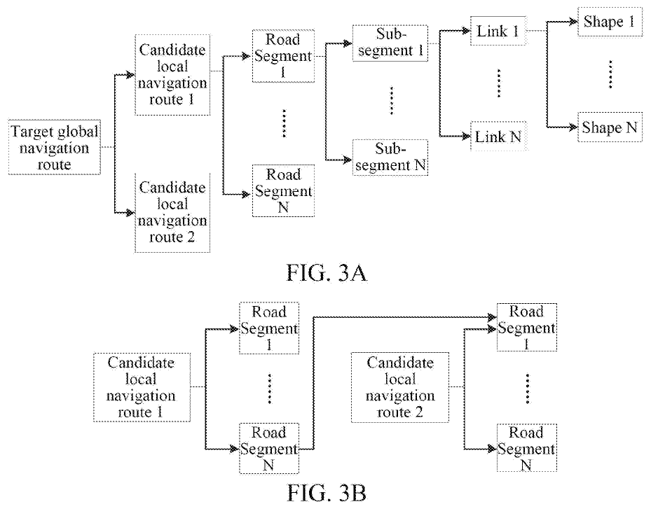

FIG. 2 is a flowchart of a method for planning a navigation route according to a first embodiment of the present disclosure. FIG. 3A-3B is schematic diagrams of the principle for determining a target global navigation route according to the first embodiment of the present disclosure. The present embodiment is applicable to the case in which the navigation route planning is performed on a global region, and particularly applicable to the case in which long-distance navigation route planning passing through at least two administrative regions is performed. The method may be performed by a cross-region-navigation server, in particular by an apparatus for planning a navigation route that is arranged in the cross-region-navigation server, the apparatus being implemented in software and/or hardware. Next, the method for planning a navigation route shown in FIG. 2 will be described in detail with reference to FIG. 3A-3B. The method specifically includes the following steps:

S201, acquire a request for global navigation of a user.

Herein, in an embodiment of the present disclosure, the request for global navigation may be a request that the user initiates through the user terminal thereof and is for requesting a navigation route between the start point of the user and the end point of the user. The request for global navigation includes the user start point and the user endpoint. The user start point may be the start point of the requested navigation route for the current time, and the user end point may be the end point of the requested navigation route for the current time. In an embodiment of the present disclosure, the travel from the user start point to the user end point needs to pass through at least two administrative regions. The administrative regions may be obtained by partitioning the global region according to a certain partitioning rule in order to perform hierarchical management on the global region. For example, according to a land-sea distribution pattern, the global region may be partitioned into seven continents, namely, Asia, Europe, Africa, North America etc., and each of the continents may serve as an administrative region; or according to the administrative partition at the national level, each nation may serve as an administrative region; or according to the administrative partition at the provincial and municipal levels, each of the countries around the world is further partitioned into provinces and municipalities, and each of the provinces or municipalities may serve as an administrative region. It should be noted that, in an embodiment of the present disclosure, the user start point and the user endpoint included in the request for global navigation may be distributed in any administrative region after the global region partition, for example, the user start point and the user end point may be distributed in different countries or continents. That is, the request for global navigation in the present disclosure may be a navigation route request for requesting a long-distance navigation route passing through at least two administrative regions.

Alternatively, in an embodiment of the present disclosure, when a user triggers the navigation instruction, the user terminal acquires the user start point and the user end point of the current navigation of the user. When the user start point and the user end point are distributed in at least two administrative regions, the user terminal generates a request for global navigation including at least the user start point and the user end point according to a request for global navigation generation rule, and sends the generated request for global navigation to the cross-region-navigation server. The cross-region-navigation server receives the request for global navigation sent by the user terminal. The navigation instruction may be triggered by the user voice or by the user clicking a preset button on the user terminal. The user endpoint and the user start point may be entered by a user. Alternatively, the user start point may also be the current location of the user terminal acquired by using a positioning technology.

For example, when the user A wants to navigate from the capital of the country A to the capital of the country B, the user A can enter the capital name of the country A at the user start point position on the navigation interface of the user terminal, enter the capital name of the country B at the user end point positon, and then click the navigation button to trigger the navigation instruction. After detecting the navigation instruction triggered by the user, the user terminal obtains the user start point and the user end point that the user wants to navigate therebetween for the current time, that is, navigate from the capital of the country A to the capital of the country B. Since this navigation crosses two countries and thus belongs to the navigation of the cross-administrative region. At this case, the user terminal generates a request for global navigation from the capital of the country A to the capital of the country B according to the request for global navigation generation rule, and sends the request for global navigation to the cross-region-navigation server, and the cross-region-navigation server obtains the request for a global navigation from the capital of the country A to the capital of the country B.

S202, generate at least two requests for local navigation for the at least two administrative regions.

The requests for local navigation may be navigation requests corresponding to the administrative regions obtained after that the request for global navigation is split according to the administrative regions passed through by the navigation route. For example, if the request for global navigation is a request for the navigation from the capital of country A to the capital of country B, the request for local navigation for the current time may be a request for a navigation in the administrative region of country A and a request for a navigation in the administrative region of country B. In an embodiment of the present disclosure, each administrative region to be passed through by the travel from the user start point to the user endpoint in the request for global navigation corresponds to at least one request for local navigation. Alternatively, a request for local navigation may include a local start point and a local end point in a local navigation process. The local start point and the local end point may be the start point and end point of the route requested by the local navigation.

Alternatively, in an embodiment of the present disclosure, after acquiring the request for global navigation of the user, the cross-region-navigation server may analyze the user start point and the user end point included in the request for global navigation, and determine the administrative regions that needs to be passed through during the travel from the user start point to the user end point; then determine, for each of the administrative regions to be passed through, a local start point and a local endpoint corresponding to the administrative region; and finally generating, according to the request for local navigation generation rule, requests for local navigation corresponding to the administrative regions based on the local start points and the local end points corresponding to the administrative regions.

For example, if the request for global navigation is a request for navigation from the capital of country A to the capital of country B, and there is no need to go through other countries from country A to country B, at least one request for local navigation corresponding to country A and at least one request for local navigation corresponding to country B need to be generated. Among the requests for local navigation generated for the administrative region of the country A, the local start point may be the capital of the country A, and the local end point may be an adjacent point between the country A and the B country, such as a gateway port between the country A and the B country. In the request for local navigation generated for the administrative region of the B country, the local end point may be the capital of the B country, and the local start point is the adjacent point between the country A and the B country.

It should be noted that how to determine a local start point and a local end point corresponding to each of the administrative regions in an embodiment of the present disclosure, and a specific execution process of generating a request for local navigation for each of the administrative regions will be described in detail in subsequent embodiments.

Alternatively, in an embodiment of the present disclosure, the cross-region-navigation server may receive requests for global navigation sent by a plurality of users simultaneously. In order to prevent request chaos between the requests for global navigations and the requests for local navigation, an embodiment of the present disclosure may establish mapping relationships between the generated requests for local navigation and a request for global navigation received in S201 when generating the requests for local navigation for the administrative regions corresponding to each of the requests for global navigation. For example, the same request identification may be set for each of the generated requests for local navigation and the request for global navigation received in S201.

S203, control at least two local-navigation servers to respectively process associated requests for local navigation.

Herein, each of the local-navigation servers is associated with at least one administrative region. Specifically, an embodiment of the present disclosure may associate at least one administrative region to each of the local-navigation servers. For example, each of the administrative regions may be configured with an associated local-navigation server; or at least two adjacent administrative regions are associated with the same local-navigation server. Specific configurations may depend on the region sizes of the administrative regions, the memory sizes of the local-navigation servers, and the like.

Alternatively, in an embodiment of the present disclosure, after generating the requests for local navigation for the administrative regions through which the travel from user start point and the user endpoint in the request for global navigation pass, the cross-region-navigation server may determine, for each of the requests for local navigation, the administrative region corresponding to the request for local navigation, and send the request for local navigation to the local-navigation server associated with the administrative region. The local-navigation server processes the received request for local navigation, performs navigation compilation process by using a navigation technology on the map data of the administrative region that is associated with the request for local navigation, obtains all the available routes in the administrative region from the local start point and the local end point included in the request for local navigation, to be served as candidate local navigation routes obtained after the request for local navigation is processed, and feeds back the candidate navigation routes to the cross-region-navigation server. It should be noted that, in embodiments of the present disclosure, the process of processing the received request for local navigation by a local-navigation server is similar to the process of processing the navigation request by a navigation server to generate a navigation route in the prior art, and embodiments of the present disclosure are not limited herein.

For example, the cross-region-navigation server sends the request for local navigation generated for the country A to the local-navigation server 1 associated with the country A, and sends the request for local navigation generated for the country B to the local-navigation server 2 associated with the country B. The local-navigation server 1 and the local-navigation server 2 process the received requests for local navigation, and obtain the candidate local navigation routes corresponding to the requests for local navigation and feedback the same to the cross-region-navigation server.

Alternatively, the local-navigation server processes the request for local navigation associated therewith, and an obtained candidate local navigation route may include route information of multi-dimensional. As the candidate local navigation route 1 in FIG. 3a, the candidate local navigation route may include a plurality of road segments, such as road segments 1 to N. For each of the road segments, a plurality of sub-segments, such as sub-segments 1 to N, may be included in the road segment. For each of the sub-segments, a plurality of links, such as links 1 to N may be included therein. For each of the link, various shapes, such as shapes 1 to N, may be included therein.

S204, determine a target global navigation route for the user based on the candidate local navigation routes fed back by the at least two local-navigation servers.

Herein in an embodiment of the present disclosure, the candidate local navigation routes may be available routes fed back by the local-navigation server and is in the administrative region associated with local-navigation server, and the available routes may all realize the travel from the local start point to the local end point. Alternatively, since the roads within the administrative region are generally interconnected, thus there are generally a plurality of candidate local navigation routes are fed back by each of the local-navigation servers to the cross-region-navigation server. The target global navigation route may be a complete navigation route from the user start point to the user end point after splicing and combining the candidate local navigation routes fed back by each of local-navigation servers.

Alternatively, in an embodiment of the present disclosure, based on the mapping relationship established between the requests for global navigation and the requests for local navigation, the cross-region-navigation server first determines, from the candidate local navigation routes fed back by each of the local-navigation servers, which ones of the candidate local navigation routes fed back by each of the local-navigation servers are the candidate local navigation routes associated with the to-be-processed request for global navigation; then, based on the positions of the candidate local navigation routes and the geographical positions of the administrative regions, traverses, starting from the user start point, the candidate navigation routes fed back by the local-navigation servers, and finds out a route connecting from the user start point to the user end point without a breakpoint to be used as the target global navigation route.

Illustratively, as shown in FIG. 3A, assuming that the candidate local navigation route 1 is a candidate local navigation route fed back by the local-navigation server 1 associated with country A, and the start point of the candidate local navigation route 1 is the capital of country A, the candidate local navigation route 2 is a candidate local navigation route fed back by the local-navigation server 2 associated with the country B, and an end point of the candidate local navigation route 2 is the capital of the country B. The country A and the country B are adjacent to each other. In this case, the candidate local navigation route 1 and the candidate local navigation route 2 may be spliced, and if there is no breakpoint from the user start point of the candidate local navigation route 1 to the user end point of the candidate local navigation route 2, it indicates that the route obtained by splicing the candidate local navigation route 1 and the candidate local navigation route 2 is a target global navigation route.

Alternatively, when judging whether there is a breakpoint in the route from the user start point to the user endpoint obtained by connecting the candidate local navigation routes fed back by the local navigation servers, the two candidate local navigation routes connected with each other may be analyzed to determine whether the last road segment of the preceding local navigation route is end-to-end connected with the first road segment of the following local navigation route. For example, as shown in FIG. 3B, it is judged whether the route segment N of the candidate local navigation route 1 is connected to the route segment 1 of the candidate local navigation route 2. If yes, it indicates that the candidate local navigation route 1 is connected to the candidate local navigation route 2 end to end, and no breakpoint exists between the two routes.

Alternatively, if all the end-to-end routes from the user start point to the user end point are used as the target global navigation routes, the number of target global navigation routes determined in this step may be relatively large, which brings inconvenience to the user selection. To solve this problem, an embodiment of the present disclosure may select an optimal target global navigation route to be pushed to the user according to a certain policy. Alternatively, based on the mapping relationship between the requests for global navigation and the requests for local navigation, the features of the candidate global navigation routes may be determined based on the candidate local navigation routes fed back by the at least two local navigation servers; and the target global navigation route of the user is determined based on the features of the candidate global navigation routes. Specifically, according to the method described above, on the basis of the mapping relationship established between the requests for global navigation and the requests for local navigation, and based on the received candidate local navigation routes fed back by the local navigation servers, a route connecting the user start point and the user end point with no breakpoint is found and used as the candidate global navigation route, that is, the candidate global navigation route can be used as a navigation route corresponding to the request for global navigation, but the candidate global navigation route is not necessarily the optimal navigation route. Then, the features of the candidate global navigation routes are determined, for example, the route lengths, the travel durations, the congestion situations or the like of the candidate global navigation routes are determined. Finally, based on the Depth-First-Search (DFS), an optimal route analysis is performed on the candidate global navigation routes based on the features of the candidate global navigation routes, from which an optimal route with a short route length and/or a short time consumed by passing through the route is selected as a final target global navigation route. Alternatively, in an embodiment of the present disclosure, the determined optimal target global navigation route may be one or more, for example, two target global navigation routes with the shortest route length and the shortest time consumption may be determined.

Alternatively, in an embodiment of the present disclosure, after determining the target global navigation route of the user, the cross-region-navigation server may generate navigation data corresponding to the target global navigation route, and feedback the navigation data to the user terminal initiating the current request for global navigation, so that the user terminal provides the current navigation service for the user based on the navigation data. Alternatively, in an embodiment of the present disclosure, when determining the navigation data based on the target global navigation route, navigation states in the current navigation process may be determined on the basis of the state machine mode. Each navigation state has its own trigger time and execution action. Moreover, trigger times or execution actions associated with different navigation states may be the same. In order to avoid repetitively compiling the relevant codes related to the trigger times and the execution actions in the development process, an embodiment of the present disclosure may encapsulate corresponding program template for each of the trigger times or the execution actions. In the process of generating the navigation data, for each navigation state, a program template of the trigger time or of the execution operation corresponding to the navigation state may be directly multiplexed.

According to the technical solution of embodiments of the present disclosure, after acquiring a request for global navigation of a user, the cross-region-navigation server partitions the request for global navigation into a plurality of requests for local navigation corresponding to a plurality of administrative regions through which a travel from the start point to the end point included in the request for global navigation passes, controls a local-navigation server corresponding to an administrative region to process the request for local navigation corresponding to the administrative region, and determines a target global navigation route of the user based on the candidate local navigation routes fed back by the local navigation servers. According to an embodiment of the present disclosure, after the cross-region-navigation server splits the request for global navigation of the user, the cross-region-navigation server requests the cooperation from a plurality of local-navigation servers to determine a target global navigation route. While the global navigation route planning across regions is implemented, the data amount processed by the cross-region-navigation server and the local-navigation server of each region is greatly reduced. It provides a new idea for global navigation route planning.

### Second Embodiment

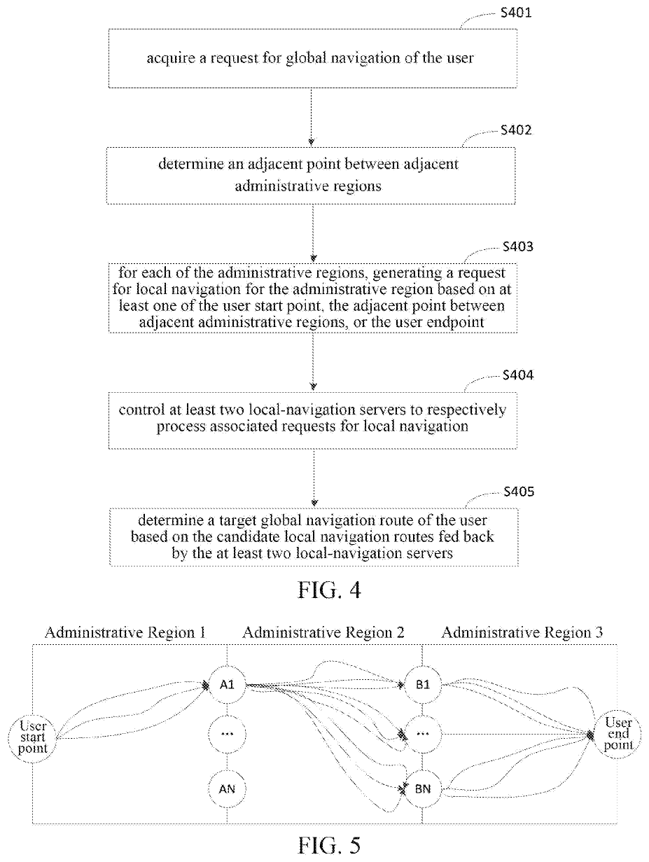

FIG. 4 is a flowchart of a method for planning a navigation route according to a second embodiment of the present disclosure. FIG. 5 is a schematic diagram of planning a route which passes through three administrative regions according to the second embodiment of the present disclosure. This embodiment is further optimized on the basis of the above-described embodiments, and provides a detailed description of generating at least two requests for local navigation for the at least two administrative regions. Next, the method for planning a navigation route shown in FIG. 4 will be described in detail with reference to FIG. 5. The method may include:

S401, acquire a request for global navigation of the user.

The request for global navigation includes a user start point and a user end point, and the travel from the user start point to the user endpoint is required to pass through at least two administrative regions.

S402, determine an adjacent point between adjacent administrative regions.

The adjacent point may be a passageway between two adjacent administrative regions, for example, a gateway between two adjacent administrative regions.

Alternatively, in an embodiment of the present disclosure, there are many ways for the cross-region-navigation server to determine an adjacent point between any two adjacent administrative regions in the administrative regions passed through by the travel from the user start point to the user end point, and this embodiment is not limited herein. An adjacent point located between two adjacent administrative regions may be determined based on historical navigation trajectory data and/or map data of the administrative regions.

Specifically, when determining an adjacent point between adjacent administrative regions based on the historical navigation trajectory data, a navigation trajectory segment located on the adjacent administrative region road segment may be extracted from the historical navigation trajectories, and the intersection point of the navigation trajectory segment and the boundary line shared by the adjacent administrative regions may be used as an adjacent point between the adjacent administrative regions. When determining an adjacent point between adjacent administrative regions based on the map data of the administrative regions, because commonly used adjacent points between adjacent administrative regions are usually collected and recorded in the map data during collection of the map data, in this case, the map data may be analyzed to directly find an adjacent point between two adjacent administrative regions. When the adjacent point between two adjacent administrative regions is determined based on the historical navigation trajectory data and map data of the administrative regions, the above two modes may be combined, so that it is advantageous to determine all the adjacent points between adjacent administrative regions more comprehensively.

Illustratively, as shown in FIG. 5, assuming that the user start point included in the request for global navigation acquired in the S401 is located in the administrative region 1, the user end point is located in the administrative region 3, and an administrative region 2 is there between the administrative region 1 and the administrative region 3. In this case, the cross-region-navigation server may find the adjacent points between the administrative region 1 and the administrative region 2 that is passed through by the travel from the user start point to the user end point, that is, the adjacent points A1 to AN, and the adjacent points between the administrative region 2 and the administrative region 3, that is, the adjacent points B1 to BN.

And S403, for each of the administrative regions, generating a request for local navigation for the administrative region based on at least one of the user start point, the adjacent point between adjacent administrative regions, or the user endpoint.

Alternatively, an embodiment of the present disclosure may first determine, for each of the administrative regions, a local start point and a local endpoint of each administrative region based on at least one of the user start point, the adjacent point located between adjacent administrative regions, or the user end point. Specifically, the following three situations are included:

Situation 1: for the administrative region in which the user start point included in the request for global navigation is located, the local start point and the local end point of the administrative region may be determined based on the user start point and an adjacent point between adjacent administrative regions. Specifically, the user start point may be used as the local start point corresponding to the administrative region, and the local end point is an adjacent point between the administrative region and a next administrative region adjacent to the administrative region. For example, as shown in FIG. 5, this situation corresponds to the administrative region 1, in which situation the user start point is used as the local start point of the administrative region 1, an adjacent point A1 to an adjacent point AN between the administrative region 1 and the administrative region 2 are used as the local end point of the administrative region 1.

Situation 2: for the administrative region in which the user end point included in the request for global navigation is located, the local start point and the local end point of the administrative region may be determined based on the user endpoint and an adjacent point between adjacent administrative regions. Specifically, the user end point may be used as the local endpoint corresponding to the administrative region, and the local start point is an adjacent point between the administrative region and a previous administrative region adjacent to the administrative region. For example, as shown in FIG. 5, this situation corresponds to the administrative region 3, where the user endpoint is used as the local endpoint of the administrative region 3, an adjoining point B1 to an adjoining point BN between the administrative region 3 and the administrative region 2 is used as the local start point of the administrative region 3.

Situation 3: for an administrative region that does not include the user start point and the user end point, the local start point and the local endpoint of the administrative region are determined based on adjacent points located between adjacent administrative regions. Specifically, an adjacent point between the administrative region and a previous administrative region adjacent to the administrative region may be used as the local start point of the administrative region, and an adjacent point between the administrative region and the next administrative region adjacent to the administrative region may be used as the local end point of the administrative region. For example, as shown in FIG. 5, this situation corresponds to the administrative region 2. In this situation, the adjacent point A1 to the adjacent point AN between the administrative region 2 and the administrative region 1 may be used as the local start point of the administrative region 2, the adjacent point B1 to the adjacent point BN between the administrative region 2 and the administrative region 3 may be used as the local end point of the administrative region 2.

Alternatively, in an embodiment of the present disclosure, for each of the administrative regions, after determining the local start point and the local end point of the administrative region, a request for local navigation may be generated for the administrative region based on the local start point and the local end point of the administrative region. Specifically, each of the local start points will go with one of the local end points to form pairs of local start point and local end point, for each of the pairs of local start point and local end point, a request for local navigation corresponding to the administrative region may be generated according to a request for local navigation generation rule. For example, as shown in FIG. 5, for the administrative region 1, a request for local navigation for the administrative region 1 may be generated based on the user start point and any one of the adjacent points A1 to AN. Similarly, for the administrative region 2, any one of the adjacent points A1 to AN may combine with any one of the adjacent points B1 to BN to generate a request for local navigation for the administrative region 2. For the administrative region 3, a request for local navigation for the administrative region 3 may be generated based on the user end point and any one of the adjacent points B1 to BN.

S404, control at least two local-navigation servers to respectively process associated requests for local navigation.

Where each of the local navigation servers is associated with at least one administrative region.

Alternatively, the cross-region-navigation server sends at least one request for local navigation corresponding to each of the administrative regions generated in the S403 to a local-navigation server associated with the administrative region, and controls each local-navigation server to process the received request for local navigation to obtain at least one candidate local navigation route corresponding to the each request for local navigation.

For example, as shown in FIG. 5, in the administrative regions, a route connecting a local start point and a local end point is a candidate local navigation route corresponding to a request for local navigation processed by a local navigation server. For example, the three routes between the user start point and the adjacent point A1 are the candidate local navigation routes starting from the user start point to the adjacent point, obtained by the local navigation server associated with the administrative region 1 processing the request for local navigation which includes the user start point (i.e. the local start point) and the adjacent point A1 (i.e., the local end point). Note that there may be corresponding candidate local navigation routes from the user start point to the adjacent points A2 to AN and from the adjacent points A2 to AN to the adjacent points B1 to BN, which are not shown in the figures.

S405, determine a target global navigation route of the user based on the candidate local navigation routes fed back by the at least two local-navigation servers.

Illustratively, as shown in FIG. 5, traversing by starting from the first candidate local navigation route from the user start point to the adjacent point A1 in the administrative region 1, the first candidate local navigation route and each of the candidate local navigation routes from the adjacent point A1 to the adjacent points B1 to BN in the administrative region 2 are spliced respectively to obtain nine primary spliced routes, and secondary splicing are performed on each of the nine primary spliced routes and the routes in the administrative region 3. For example, after the primary splicing, secondary splicing is respectively performed on the first primary spliced route that includes the segment starting from the adjacent point A1 to the adjacent point B1 and the three routes from the adjacent point B1 to the user end point; secondary splicing is respectively performed on the first primary spliced route that includes the segment starting from the adjacent point A1 to the adjacent point BN and the three routes between the adjacent point BN to the user end point. The candidate local navigation routes not shown in FIG. 5 are spliced in the same manner to obtain a target global navigation route. Alternatively, the routes after the secondary splicing may be used as the candidate global navigation routes, to determine features of the candidate global navigation routes, and an optimal target global navigation route is determined based on the features of the candidate global navigation routes.

According to the technical solution of embodiments of the present disclosure, after acquiring a request for global navigation of the user, the cross-region navigation server determines the adjacent points between adjacent administrative regions in at least two administrative regions, and generates the requests for local navigation corresponding to the administrative regions according to the user start points, the user end point and the determined adjacent points between adjacent administrative regions included in the request for global navigation. A local navigation server corresponding to each of the administrative regions is controlled to process a request for local navigation corresponding to the administrative region, and a target global navigation route of a user is then determined according to the candidate local navigation routes fed back by the local navigation servers.

According to embodiments of the present disclosure, the accuracy and comprehensiveness of the partitioned requests for local navigation are improved, and the data processing amount of the cross-region-navigation server and a local navigation server corresponding to each region is greatly reduced while the cross-region global navigation route planning is realized. It provides a new idea for planning a global navigation route.

### Third Embodiment

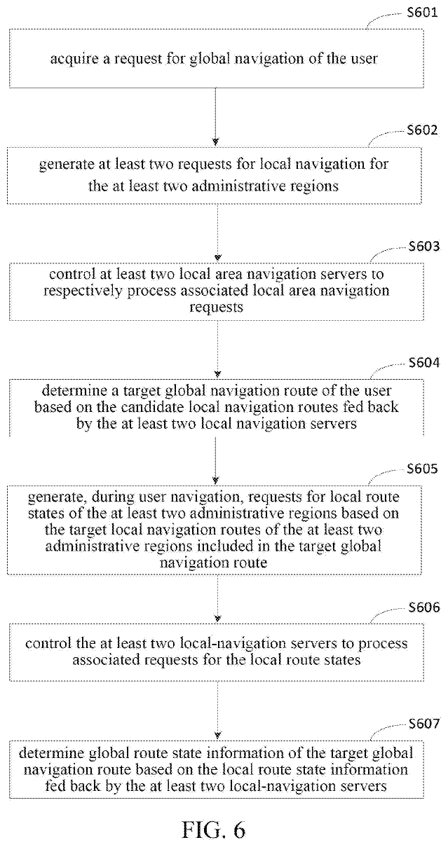

FIG. 6 is a flowchart of a method for planning a navigation route according to a third embodiment of the present disclosure. On the basis of the above-described embodiments, the present embodiment performs further optimization, and provides a detailed description of the situation in which the global route state information of the target global navigation route is determined in the user navigation process. As shown in FIG. 6, the method may include:

S601, acquire a request for global navigation of the user.

Where the request for global navigation includes a user start point and a user end point, and travel from the user start point to the user endpoint is required to pass through at least two administrative regions.

S602, generate at least two requests for local navigation for the at least two administrative regions.

S603, control at least two local area navigation servers to respectively process associated local area navigation requests.

Where each of the local-navigation servers is associated with at least one administrative region.

S604, determine a target global navigation route of the user based on the candidate local navigation routes fed back by the at least two local navigation servers.

S605, generate, during user navigation, requests for local route states of the at least two administrative regions based on the target local navigation routes of the at least two administrative regions included in the target global navigation route.

In an embodiment of the present disclosure, the target local navigation route may be a local sub-route segment of a target global navigation route corresponding to each of the administrative regions. The local route state may be a traffic state of a target local navigation route, for example, may include, but is not limited to, a navigation state, a real-time road condition, a remaining travel duration, guidance information, signal light information, and the like, of a local route.

Alternatively, in an embodiment of the present disclosure, after determining the target global navigation route of the user, the cross-region-navigation server feeds back navigation data of the target global navigation route to the user terminal, so that the user terminal provides the current navigation service for the user based on the received navigation data of the target global navigation route. In order to provide a high-quality navigation service to a user during the user drives according to the navigation route, so that the user understands the route state information of the driving route during navigation. The cross-region-navigation server may differentiate the target global navigation route to obtain target local navigation routes corresponding to the at least two administrative regions, and generate a local route state request for each target local navigation route according to the relevant rules for generating the route state request. Alternatively, the local route state request may include a route name, a route identifier, and the like of the target local navigation route to be determined. Alternatively, to prevent request chaos between the target global navigation route and the local route state requests of the target local navigation routes, when generating the local route state requests, an embodiment of the present disclosure may establish a mapping relationship between the generated local route state requests and the target global navigation route. For example, the route identification same as that of the target global navigation route may be set for the requests for local route states.

S606, control the at least two local-navigation servers to process associated requests for the local route states.

Alternatively, after the cross-region-navigation server generates the requests for local route states for the at least two administrative regions at S605, for each of the requests for local route states, the cross-region-navigation server sends, according to the administrative region to which the target local navigation route corresponding to the request for local route state belongs, the request for local route state to the local navigation server associated with the administrative region, so as to control the local-navigation server to process the request for local route state, to obtain the local route state information of the target local navigation route included in the request for local route state, and feed back the obtained local route state information corresponding to the request for local route state to the cross-region-navigation server.

S607, determine global route state information of the target global navigation route based on the local route state information fed back by the at least two local-navigation servers.

Alternatively, after receiving the local route state information fed back by each of the local navigation servers, the cross-region-navigation server determines the local route state information fed back by each of the requests for local route state corresponding to the target global navigation route based on the mapping relationship between the requests for local route state and the target global navigation route, and then integrates the determined local route state information to obtain the global route state information of the target global navigation route. For example, the local route state information and the target global navigation route may be fused, and the corresponding road state information is added to the target global navigation route on the navigation page, so that the user can more intuitively understand the route state of the target global navigation route.

Alternatively, an embodiment of the present disclosure may further analyze whether the current target global navigation route is the optimal route according to the determined global route state information of the target global navigation route. If affected by the route state, such as heavily road congestion, the target global navigation route is no longer the optimal route. In this case, the operation of S604 may be re-executed to re-determine the optimal target global navigation route for the user.

According to the technical solution of embodiments of the present disclosure, after acquiring a request for global navigation of a user, a cross-region-navigation server partitions the request for global navigation into a plurality of requests for local navigation corresponding to a plurality of administrative regions through which a travel from a start point to an end point included in the request for global navigation pass, controls a local navigation server corresponding to an administrative region to process the request for local navigation corresponding to the administrative region, and determines a target global navigation route of the user according to candidate local navigation routes fed back by the local navigation servers. Therefore, cross-regional global navigation route planning is realized. After the target global navigation route is determined, a request for local route state can be generated and sent to a local navigation server corresponding to an administrative region in a user navigation process, and global route state information of the entire target global navigation route can be obtained and provided to the user according to the local route state information fed back by the local navigation servers, so that the user can know the route state in the navigation process in real time, thereby enriching the navigation service function and improving the navigation experience of the user.

### Fourth Embodiment

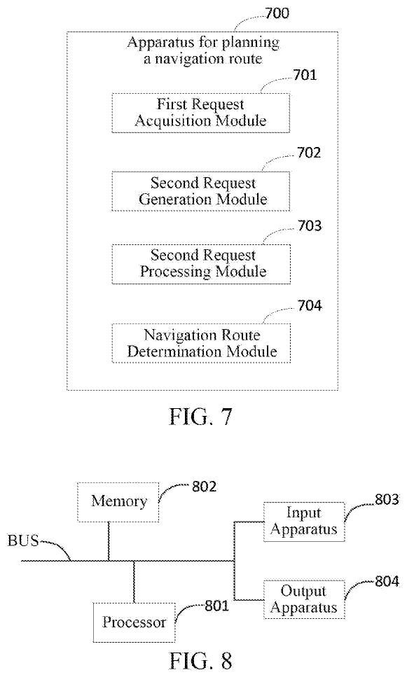

FIG. 7 is a schematic structural diagram of an apparatus for planning a navigation route according to a fourth embodiment of the present disclosure. The present embodiment may be applicable to a case of planning a navigation route for a global region, and particularly to a case of planning a long-distance navigation route which passes through at least two administrative regions. The device may be configured in a cross-region-navigation server. The apparatus 700 comprises, in particular, as follows:

A first request acquisition module 701, configured to acquire a request for global navigation of a user, wherein the request for the global navigation includes a user start point and a user end point, and travel from the user start point to the user end point is required to pass through at least two administrative regions;

A second request generation module 702, configured to generate at least two requests for local navigation for the at least two administrative regions;

A second request processing module 703, configured to control at least two local-navigation servers to respectively process associated requests for the local navigation, wherein each of the local navigation servers is associated with at least one of the administrative regions; and

A navigation route determination module 704, configured to determine a target global navigation route for the user based on candidate local navigation routes fed back by the at least two local-navigation servers.

According to the technical solution of embodiments of the present disclosure, after acquiring a request for global navigation of a user, the cross-region-navigation server partitions the request for global navigation into a plurality of requests for local navigation corresponding to a plurality of administrative regions through which a travel from the start point to the end point included in the request for global navigation passes, controls a local-navigation server corresponding to an administrative region to process the request for local navigation corresponding to the administrative region, and determines a target global navigation route of the user based on a candidate local navigation route fed back by each local navigation server. According to an embodiment of the present disclosure, after the cross-region-navigation server splits the request for global navigation of the user, the cross-region-navigation server requests the cooperation from a plurality of local-navigation servers to determine a target global navigation route. While the global navigation route planning across regions is implemented, the data amount processed by the cross-region-navigation server and the local-navigation server of each region is greatly reduced. It provides a new idea for global navigation route planning.

Further, the second request generation module 702 includes:

an adjacent point determination unit, configured to determine an adjacent point between adjacent administrative regions; and

a second request generation unit, configured to generate, for each of the adjacent administrative regions, a request for the local navigation for the administrative region based on at least one of the user start point, the adjacent point between the adjacent administrative regions, or the user end point.

Further, the adjacent point determination unit is further configured to:

determine the adjacent point between the adjacent administrative regions based on historical navigation trajectory data and map data of the adjacent administrative regions.

Further, the second request generation unit is further configured to:

determine a local start point and a local end point of the administrative region based on at least one of the user start point, the adjacent point between the adjacent administrative regions, or the user end point; and

generate the request for the local navigation for the administrative region based on the local start point and the local end point of the administrative region.

Further, the navigation route determination module 704 is further configured to:

determine features of candidate global navigation routes, according to a mapping relationship between the request for the global navigation and the requests for the local navigation, and based on the candidate local navigation routes fed back by the at least two local navigation servers; and

determine the target global navigation route for the user according to the features of the candidate global navigation routes.

Further, the apparatus further includes:

a third request generation module, configured to generate, during user navigation, requests for local route states of the at least two administrative regions based on the target local navigation routes of the at least two administrative regions included in the target global navigation route;

a third request processing module, configured to control the at least two local-navigation servers to process associated requests for the local route states; and

a route state generation module, configured to determine global route state information of the target global navigation route based on local route state information fed back by the at least two local-navigation servers.

### Fifth Embodiment

Some embodiments of the present disclosure further provide a server and a readable storage medium.

FIG. 8 is a block diagram of a server for implementing a method for planning a navigation route according to an embodiment of the present disclosure. The server is intended to represent various forms of digital computers, such as laptop computers, desktop computers, workstations, personal digital assistants, servers, blade servers, mainframe computers, and other suitable computers. The server may also represent various forms of mobile devices, such as personal digital processing, cellular telephones, smart phones, wearable devices, and other similar computing devices. The components shown herein, their connections and relationships, and their functions are by way of example only and are not intended to limit the implementation of the present disclosure as described and/or claimed herein.

As shown in FIG. 8, the server includes one or more processors 801, a memory 802, and an interface for connecting components, including high-speed interfaces and low-speed interfaces. The various components are connected to each other using different buses, and may be installed on a common motherboard or in other methods as required. The processor may process instructions executed within the server, including instructions stored in or on the memory to display graphic information of GUI on an external input/output apparatus (such as a display device coupled to the interface). In other embodiments, a plurality of processors and/or a plurality of buses may be used together with a plurality of memories if desired. Similarly, a plurality of electronic devices may be connected, and the devices provide some necessary operations (for example, as a server array, a set of blade servers, or a multi-processor system). In FIG. 8, one processor 801 is used as an example.

The memory 802 is a non-transitory computer readable storage medium provided in some embodiments of the present disclosure. The memory stores instructions executable by at least one processor, so that the at least one processor performs the method for planning a navigation route provided by some embodiments of the present disclosure. The non-transitory computer readable storage medium of the present disclosure stores computer instructions for causing a computer to perform the method for planning a navigation route provided by some embodiments of the present disclosure.

As a non-transitory computer readable storage medium, the memory 802 may be used to store non-transitory software programs, non-transitory computer executable programs and modules, for example, the program instructions/modules corresponding to the method for planning a navigation route in the embodiments of the present disclosure (for example, the first request acquisition module 701, the second request generation module 702, second request processing module 703, and the navigation route determination module 704 shown in FIG. 7). The processor 801 runs the non-transitory software programs, instructions, and modules stored in the memory 802 to execute various functional applications and data processing of the server, that is, to implement the method for planning a navigation route of the above method embodiments.

The memory 802 may include a program storage area and a data storage area. The program storage area may store an operating system and an application required for at least one function. The data storage area may store data and the like created according to the usage of a terminal device. In addition, the memory 802 may include a high-speed random access memory, and may also include a non-volatile memory, e.g., at least one disk storage device, a flash memory device or other non-volatile solid-state storage devices. In some embodiments, the memory 802 may further include memories remotely arranged relative to the processor 801, where the remote memories may be connected to the terminal device by a network. An example of the above network includes but not limited to, the Internet, an enterprise intranet, a local area network, a mobile communications network, and a combination thereof.

The server for implementing the method for planning a navigation route may further include: an input apparatus 803 and an output apparatus 804. The processor 801, the memory 802, the input apparatus 803, and the output apparatus 804 in the device may be connected via a bus or in other modes. Connection by a bus is used as an example in FIG. 8.

The input apparatus 803 may receive input digital or character information, and generate key signal inputs related to user settings and function control of a server used to implement the method for planning a navigation route, such as a touch screen, a keypad, a mouse, a trackpad, a touchpad, a pointer stick, one or more mouse buttons, a trackball, a joystick, and other input apparatuses. The output apparatus 804 may include a display device, an auxiliary lighting device such as a Light Emitting Diode (LED), a touch feedback device, and the like, a tactile feedback apparatus, for example, a vibration motor or the like. The display device may include, but is not limited to, a Liquid Crystal Display (LCD), a light emitting diode (LED) display, and a plasma display. In some embodiments, the display device may be a touch screen.

Various embodiments of the systems and technologies described herein may be implemented in digital electronic circuit systems, integrated circuit systems, dedicated application specific integrated circuits (ASIC), computer hardware, firmware, software, and/or combinations thereof. These various embodiments may include: being implemented in one or more computer programs that may be executed and/or interpreted on a programmable system that includes at least one programmable processor. The programmable processor may be a dedicated or general purpose programmable processor, and may receive data and instructions from a memory system, at least one input apparatus, and at least one output apparatus, and transmit the data and instructions to the storage system, the at least one input apparatus, and the at least one output apparatus.

These computing programs, also referred to as programs, software, software disclosures, or codes, include machine instructions of a programmable processor, and may be implemented using high-level procedures and/or object-oriented programming languages, and/or assembly/machine languages. As used herein, the terms “machine readable medium” and “computer readable medium” refer to any computer program product, device, and/or apparatus (for example, magnetic disk, optical disk, memory, programmable logic apparatus (PLD)) used to provide machine instructions and/or data to the programmable processor, including machine readable medium that receives machine instructions as machine readable signals. The term “machine readable signal” refers to any signal used to provide machine instructions and/or data to the programmable processor.

To provide interaction with a user, the systems and technologies described herein may be implemented on a computer, the computer has: a display apparatus for displaying information to the user, such as a Cathode Ray Tube (CRT) or an liquid crystal display (LCD) monitor; and a keyboard and pointing apparatus, such as a mouse or a trackball, and a user may use the keyboard and the pointing apparatus to provide input to the computer. Other types of apparatuses may also be used to provide interaction with the user. For example, the feedback provided to the user may be any form of sensory feedback, such as visual feedback, auditory feedback, or tactile feedback; and any form (including acoustic input, voice input, or tactile input) may be used to receive input from the user.

The systems and technologies described herein may be implemented in a computing system that includes backend components, e.g., as a data server, or in a computing system that includes middleware components, e.g., an application server, or in a computing system including front-end components, e.g., a user computer having a graphical user interface or a web browser through which a user may interact with embodiments of the systems and technologies described herein, or in a computing system including any combination of such backend components, middleware components, or front-end components. The components of the system may be interconnected by any form or medium of digital data communication, e.g., a communication network. Examples of communication networks include: Local Area Network (LAN), Wide Area Network (WAN), the Internet, and block chain networks.

The computer system may include a client and a server. The client and server are generally far from each other and usually interact through a communication network. The relationship between the client and the server is generated by computer programs that run on the corresponding computer and having a client-server relationship with each other.

According to the technical solution of embodiments of the present disclosure, after acquiring a request for global navigation of the user, the cross-region-navigation server partitions the request for global navigation into a plurality of requests for local navigation corresponding to a plurality of administrative regions through which the travel from the start point to the endpoint of the request for global navigation passes, controls the local navigation servers corresponding to administrative regions to process the requests for local navigation corresponding to the administrative regions, and determines the target global navigation route of the user according to the candidate local navigation routes fed back by the local navigation servers. According to embodiments of the present disclosure, after the cross-region-navigation server splits the request for global navigation of the user, a plurality of local navigation servers are requested to cooperate to determine the target global navigation route. While the global navigation route planning across regions is implemented, the data processing amount of the cross-region-navigation server and a local navigation server of each region is greatly reduced. It provides a new idea for global navigation route planning.

It should be understood that the various forms of processes shown above may be used to reorder, add, or delete steps. For example, the steps described in embodiments of the present disclosure may be performed in parallel, sequentially, or in different orders. As long as the desired results of the technical solution disclosed in embodiments of the present disclosure can be achieved, no limitation is made herein.

The above specific embodiments do not constitute limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for planning a navigation route, performed by a cross-region-navigation server, the method comprising:
acquiring a request for global navigation, wherein the request for the global navigation includes a user start point and a user end point, and travel from the user start point to the user end point is required to pass through at least two administrative regions;
generating at least two requests for local navigation for the at least two administrative regions;
controlling at least two local-navigation servers to respectively process associated requests for the local navigation, wherein each of the local navigation servers is associated with at least one of the administrative regions; and
determining a target global navigation route based on candidate local navigation routes fed back by the at least two local-navigation servers.

2. The method according to claim 1, wherein the generating at least two requests for the local navigation for the at least two administrative regions comprises:
determining an adjacent point between adjacent administrative regions; and
for each of the adjacent administrative regions, generating a request for the local navigation for the administrative region based on at least one of the user start point, the adjacent point between the adjacent administrative regions, or the user end point.

3. The method according to claim 2, wherein the determining the adjacent point between the adjacent administrative regions comprises:
determining the adjacent point between the adjacent administrative regions based on historical navigation trajectory data and map data of the adjacent administrative regions.

4. The method according to claim 2, wherein the generating the request for the local navigation for the administrative region based on at least one of the user start point, the adjacent point between the adjacent administrative regions, or the user end point comprises:
determining a local start point and a local end point of the administrative region based on at least one of the user start point, the adjacent point between the adjacent administrative regions, or the user end point; and
generating the request for the local navigation for the administrative region based on the local start point and the local end point of the administrative region.

5. The method according to claim 1, wherein the determining the target global navigation route based on the candidate local navigation routes fed back by the at least two local-navigation servers comprises:
determining features of candidate global navigation routes, according to a mapping relationship between the request for the global navigation and the requests for the local navigation, and based on the candidate local navigation routes fed back by the at least two local navigation servers; and
determining the target global navigation route for the user according to the features of the candidate global navigation routes.

6. The method according to claim 1, wherein after the determining the target global navigation route, the method further comprises:
generating, during user navigation, requests for local route states of the at least two administrative regions based on the target local navigation routes of the at least two administrative regions included in the target global navigation route;
controlling the at least two local-navigation servers to process associated requests for the local route states; and
determining global route state information of the target global navigation route based on local route state information fed back by the at least two local-navigation servers.

7. An apparatus for planning a navigation route, the apparatus comprising:
at least one processor; and
a memory storing instructions, the instructions when executed by the at least one processor, cause the at least one processor to perform operations, the operations comprising:
acquiring a request for global navigation, wherein the request for the global navigation includes a user start point and a user end point, and travel from the user start point to the user end point is required to pass through at least two administrative regions;
generating at least two requests for local navigation for the at least two administrative regions;
controlling at least two local-navigation servers to respectively process associated requests for the local navigation, wherein each of the local navigation servers is associated with at least one of the administrative regions; and
determining a target global navigation route based on candidate local navigation routes fed back by the at least two local-navigation servers.

8. The apparatus according to claim 7, wherein the generating at least two requests for the local navigation for the at least two administrative regions comprises:
determining an adjacent point between adjacent administrative regions; and
for each of the adjacent administrative regions, generating a request for the local navigation for the administrative region based on at least one of the user start point, the adjacent point between the adjacent administrative regions, or the user end point.

9. The apparatus according to claim 8, wherein the determining the adjacent point between the adjacent administrative regions comprises:
determining the adjacent point between the adjacent administrative regions based on historical navigation trajectory data and map data of the adjacent administrative regions.

10. The apparatus according to claim 8, wherein the generating the request for the local navigation for the administrative region based on at least one of the user start point, the adjacent point between the adjacent administrative regions, or the user end point comprises:
determining a local start point and a local end point of the administrative region based on at least one of the user start point, the adjacent point between the adjacent administrative regions, or the user end point; and
generating the request for the local navigation for the administrative region based on the local start point and the local end point of the administrative region.

11. The apparatus according to claim 7, wherein the determining the target global navigation route based on the candidate local navigation routes fed back by the at least two local-navigation servers comprises:
determining features of candidate global navigation routes, according to a mapping relationship between the request for the global navigation and the requests for the local navigation, and based on the candidate local navigation routes fed back by the at least two local navigation servers; and
determining the target global navigation route for the user according to the features of the candidate global navigation routes.

12. The apparatus according to claim 7, wherein after the determining the target global navigation route, the operations further comprise:
generating, during user navigation, requests for local route states of the at least two administrative regions based on the target local navigation routes of the at least two administrative regions included in the target global navigation route;
controlling the at least two local-navigation servers to process associated requests for the local route states; and
determining global route state information of the target global navigation route based on local route state information fed back by the at least two local-navigation servers.

13. A non-transitory computer-readable storage medium storing computer instructions, wherein the computer instructions, when executed by a processor, cause the processor to perform operations, the operations comprising:
acquiring a request for global navigation, wherein the request for the global navigation includes a user start point and a user end point, and travel from the user start point to the user end point is required to pass through at least two administrative regions;
generating at least two requests for local navigation for the at least two administrative regions;
controlling at least two local-navigation servers to respectively process associated requests for the local navigation, wherein each of the local navigation servers is associated with at least one of the administrative regions; and
determining a target global navigation route based on candidate local navigation routes fed back by the at least two local-navigation servers.

14. The medium according to claim 13, wherein the generating at least two requests for the local navigation for the at least two administrative regions comprises:
determining an adjacent point between adjacent administrative regions; and
for each of the adjacent administrative regions, generating a request for the local navigation for the administrative region based on at least one of the user start point, the adjacent point between the adjacent administrative regions, or the user end point.

15. The medium according to claim 14, wherein the determining the adjacent point between the adjacent administrative regions comprises:
determining the adjacent point between the adjacent administrative regions based on historical navigation trajectory data and map data of the adjacent administrative regions.

16. The medium according to claim 14, wherein the generating the request for the local navigation for the administrative region based on at least one of the user start point, the adjacent point between the adjacent administrative regions, or the user end point comprises:
determining a local start point and a local end point of the administrative region based on at least one of the user start point, the adjacent point between the adjacent administrative regions, or the user end point; and
generating the request for the local navigation for the administrative region based on the local start point and the local end point of the administrative region.

17. The medium according to claim 13, wherein the determining the target global navigation route based on the candidate local navigation routes fed back by the at least two local-navigation servers comprises:
determining features of candidate global navigation routes, according to a mapping relationship between the request for the global navigation and the requests for the local navigation, and based on the candidate local navigation routes fed back by the at least two local navigation servers; and
determining the target global navigation route for the user according to the features of the candidate global navigation routes.

18. The medium according to claim 13, wherein after the determining the target global navigation route, the operations further comprise:
generating, during user navigation, requests for local route states of the at least two administrative regions based on the target local navigation routes of the at least two administrative regions included in the target global navigation route;
controlling the at least two local-navigation servers to process associated requests for the local route states; and
determining global route state information of the target global navigation route based on local route state information fed back by the at least two local-navigation servers.
